(19) United States
(12) Patent Application Publication
(10) Pub. No.: US 2026/0184890 A1
(43) Pub. Date: Jul. 2, 2026

(54) COMPOSITIONS AND METHODS FOR REDUCING FORMALDEHYDE IN ACRUYLIC OR STYRENE-ACRYLIC POLYMERIC PRODUCTS

(71) Applicant: Dow Global Technologies LLC, Midland, MI (US)

(72) Inventors: Bo Tong, Shanghai (CN); Ling Zhong, Shanghai (CN); Cheng Shen, Shanghai (CN); Zhengming Tang, Shanghai (CN)

(21) Appl. No.: 19/131,260

(22) PCT Filed: Nov. 11, 2022
(86) PCT No.: PCT/CN2022/134906

§ 371 Date: May 20, 2025

(51) Int. Cl. C08K 5/07; C08K 5/17

(52) U.S. Cl. CPC C08K 5/07; C08K 5/17

(57) ABSTRACT

A unique aqueous polymeric composition comprising a combination of an aqueous dispersion of polyacrylic or poly-styrene-acrylic particles, at least one cyclic multi-carbonyl compound and at least one hydroxyl group-functionalized amine compound is provided, wherein the combination can substantially reduce or even completely eliminate the formaldehyde in acrylic or styrene-acrylic based products, such as coating material, paint, primer, adhesive, sealing agent, etc., produced therefrom, without incurring any degradation in the performance properties of the product. A process for preparing the product and a method for reducing or eliminating formaldehyde in the product are also provided.

### FIELD OF THE INVENTION

The present disclosure relates to formaldehyde emission control, and specifically, to a technology for reducing the emission of free formaldehyde from acrylic or styrene-acrylic polymeric products.

### BACKGROUND

Formaldehyde (FA), which is generally contained in various commercial products such as coating materials, adhesives, building materials, interior decoration, etc., has been classified as a Class I carcinogen by the International Agency for Research on Cancer (IARC). The free formaldehyde contained in an acrylic/styrene acrylic coating or adhesive could be a more serious concern since the free formaldehyde emitted from the clear primers, cementitious waterproofing coatings, decoration layers or other indoor building parts formed with the acrylic/styrene acrylic coating or adhesive will accumulate within an enclosed indoor building environment and incur risk to the construction workers and inhabitants in the vicinity. Many countries have instituted regulatory standards pertaining to the health risk associated with free formaldehyde. For example, Chinese standards JG/T 468-2015, “Interface Treating Agent for Interior Building Wall”, JC/T 907-2018, “Interface Treating Agent for Concrete” and GB50325-2020, “Standard for Indoor Environmental Pollution Control of Civil Building Engineering” require that the concentration of free formaldehyde shall be kept at a level of less than 100 mg/kg, i.e., less than 100 ppm.

Considerable efforts have been made in the past decades to reduce or eliminate the environmental and health risk associated with free formaldehyde emission and to meet the increasingly stricter environmental protection requirements around the world. For example, the researchers of the coating field have carefully designed the coating formulation so as to minimize the inclusion of any formaldehyde or formaldehyde-generating substance (e.g., sodium formaldehyde sulfoxylate) therein. However, up to now all the commercial manufactures still have to trade off the environmental production against other factors such as manufacture cost, coating/adhesive performance properties, etc. Furthermore, even if any formaldehyde-containing or formaldehyde-generating components have been strictly excluded from the acrylic coating/adhesive formulation, a trace amount of formaldehyde may still be introduced therein as byproducts or unavoidable contaminates.

Several formaldehyde scavengers have been reported as supplementary means for alleviating the existing problems, but various disadvantages still remain. For example, their scavenging efficiency could be so insufficient that the preparation of a formaldehyde-free acrylic coating/adhesive is either impracticable or has to be done by using undesirably high additional amounts of scavengers. The addition of scavengers may incur the formation of substantial amounts of hazardous byproducts, such as volatile organic amines, etc., as well as deterioration in the performance properties such as stability. Another problem is that most of these formaldehyde scavengers requires a rather high pH condition or high scavenger addition amount which may lead to addition problems such as unpleasant odor, color change (e.g. brownish/yellowish). Besides, the scavengers suitable for other coating/adhesive systems, e.g. the PU-based system which generally includes polymerization under waterless conditions, are usually unsuitable for the aqueous acrylic based system, which further increases the difficulty in developing new formaldehyde removal technology for the aqueous acrylic based system.

In view of the above, technologies which can effectively reduce formaldehyde concentration in an acrylic coating/adhesive at a normal pH range of e.g. from 2 to 10, while retaining various performance properties and avoiding the above said disadvantages, is highly desirable for meeting the requirements from the customer and as well as the existing and future Environmental Protection Regulations, and further enhancing the product competitiveness.

After persistent exploration, we have surprisingly developed a technology which can achieve the above targets.

### SUMMARY OF THE INVENTION

In a first aspect of the present disclosure, the present disclosure provides a unique aqueous polymeric composition, comprising (a) an aqueous dispersion of polymeric particles comprising acrylic polymer, styrene-acrylic polymer or a combination thereof, wherein the aqueous dispersion comprises formaldehyde; (b) at least one cyclic multi-carbonyl compound; and (c) at least one hydroxyl group-functionalized amine compound; wherein the at least one cyclic multi-carbonyl compound and the at least one hydroxyl group-functionalized amine compound are formaldehyde-scavenging.

In a second aspect of the present disclosure, a product obtained from the aqueous polymeric composition of the present disclosure is provided, wherein the aqueous product is an adhesive, a coating material a paint or a sealing agent, and the product has a free formaldehyde concentration of less than that in the aqueous dispersion.

In a third aspect of the present disclosure, a method for preparing a product with reduced formaldehyde by using the aqueous polymeric composition of the present disclosure is provided, wherein the product is an adhesive, a coating material, a paint or a sealing agent, and the method comprises a step of combining an aqueous dispersion comprising polymeric particles comprising acrylic polymer, styrene-acrylic polymer or a combination thereof, with the cyclic multi-carbonyl compound and the hydroxyl group-functionalized amine compound.

In a fourth aspect of the present disclosure, a method for reducing formaldehyde content in the product of the present disclosure is provided, wherein the method comprises the following steps: providing an aqueous dispersion comprising polymeric particles comprising acrylic polymer, styrene-acrylic polymer or a combination thereof, wherein the aqueous dispersion has a first free formaldehyde concentration; and adding the cyclic multi-carbonyl compound and the hydroxyl group-functionalized amine compound into the aqueous dispersion so as to reduce the formaldehyde to a second free formaldehyde concentration, wherein the second free formaldehyde concentration is less than 90% of the first free formaldehyde concentration.

It is to be understood that both the foregoing general description and the following detailed description are exemplary and explanatory only and are not restrictive of the invention, as claimed.

### BRIEF DESCRIPTION OF THE DRAWINGS

FIG. 1 shows a schematic process flow chart according to an embodiment of the present disclosure.

### DETAILED DESCRIPTION OF THE INVENTION

Unless defined otherwise, all technical and scientific terms used herein have the same meaning as commonly understood by one of ordinary skill in the art to which the invention belongs. Also, all publications, patent applications, patents, and other references mentioned herein are incorporated by reference. As disclosed herein, “and/or” means “and, or as an alternative”. All ranges include endpoints unless otherwise indicated.

As used herein, the terms “reduced formaldehyde”, “reducing formaldehyde” and “reduced free formaldehyde concentration” are interchangeable and refer to the scavenging of the free formaldehyde contained in the acrylic or styrene-acrylic based aqueous dispersion to any extent, such as less than 70%, or less than 50%, or less than 30% of the original free formaldehyde concentration before the addition of the binary formaldehyde-scavenging system.

As used herein, the content of the free formaldehyde is characterized by High Performance Liquid Chromatography (HPLC), e.g. can be characterized according to GB/T 30982-2014.

According to an exemplary embodiment, the present disclosure provides an aqueous polymeric composition, comprising (a) an aqueous dispersion comprising polymeric particles comprising acrylic polymer, styrene-acrylic polymer or a combination thereof; (b) at least one cyclic multi-carbonyl compound; and (c) at least one hydroxyl group-functionalized amine compound.

According to some embodiments, the aqueous polymeric composition of the present disclosure can be considered as a “raw material package” or “precursor package” for preparing the acrylic or styrene-acrylic product with reduced formaldehyde, which can be an adhesive, a coating material, a primer, a paint, a sealing agent, etc. For example, the formaldehyde-free acrylic or styrene-acrylic product can be prepared by combining all the components of said “raw material package” or “precursor package”. According to an embodiment, the polymeric particles in the aqueous dispersion (a) are solid component or precursor component for the acrylic or styrene-acrylic product, and the aqueous dispersion may include an aqueous suspension, an emulsion or an aqueous latex. According to an embodiment, the aqueous dispersion comprises from 5 wt % to 60 wt % of the polymeric particles, based on the weight of the aqueous dispersion, such as from 10 wt % to 55 wt %, or from 20 to 52 wt %, or from 30 wt % to 50 wt %, or from 40 wt % to 57 wt %, or within a numerical range obtained by combination any two of the above said end points. According to another embodiment, the aqueous dispersion comprising the polymeric particles may have a first free formaldehyde concentration which needs to be further reduced so as to e.g. meet the regulations of a specific country/region or further enhance the product competitiveness. For example, the first free formaldehyde concentration can be from 10 to 2,000 ppm, or from 12 to 1,000 ppm, or from 15 to 500 ppm, or from 20 to 200 ppm, or from 50 to 100 ppm, or within a numerical range obtained by combination any two of the above said end points. According to one embodiment, the aqueous dispersion comprising the polymeric particles (a) may have been qualified as a commercialized product (e.g., an adhesive, a coating material, a primer, a paint, a sealing agent, etc.) since the first free formaldehyde concentration thereof meets the requirements of local environmental regulations, and the components (b) and (c) are added therein so as to further reduce the first free formaldehyde concentration (e.g. to a reduced second free formaldehyde concentration) so as to enhance the quality and competitiveness of the product. According to an embodiment, the aqueous dispersion is free of organic solvent.

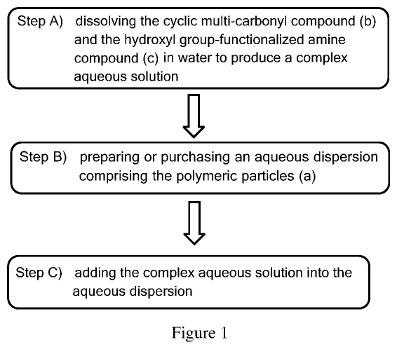

FIG. 1 shows the schematic process flow chart of a process for reducing the free formaldehyde concentration of a styrene-acrylic dispersion (latex) and a method for producing a styrene-acrylic product (e.g. a waterproof adhesive). As shown in FIG. 1, the process comprise: Step A) dissolving the cyclic multi-carbonyl compound (b) and the hydroxyl group-functionalized amine compound (c) in an aqueous solvent, e.g. water, to form an aqueous solution, which is known as a “complex solution” as it is a complex of binary formaldehyde-scavenging system; Step B) providing, e.g. by preparing or purchasing, an aqueous dispersion comprising the polymeric particles (a); and Step C) adding the complex solution into the aqueous dispersion to produce the styrene-acrylic based product with reduced formaldehyde content.

According to an embodiment, in the step A), the cyclic multi-carbonyl compound and the hydroxyl group-functionalized amine compound are dissolved in an aqueous solvent, such as water, to form two separate aqueous solutions for each compound, or to form one aqueous solution comprising both. The aqueous solution may have a solid content, by weight based on the total weight of the solution, of from 5 wt % to 40 wt %, such as from 10 wt % to 30 wt %, or from 20 wt % to 25 wt %. As used herein, the aqueous solution is known as a “complex solution” as it is a complex of binary formaldehyde-scavenging system. According to an embodiment, the aqueous solution is free of organic solvent, i.e. water is exclusively used as the solvent for the complex solution. According to an embodiment, the preparation of the aqueous complex solution can be conducted at any temperature and an elevated temperature can be adopted for promoting the dissolution. According to a specific embodiment, the aqueous complex solution is prepared at ambient temperature.

According to an embodiment, in the step B) as shown in FIG. 1, the aqueous dispersion is provided by the polymerization of at least one acrylic monomer or the combination of at least one acrylic monomer and at least one styrene monomer. According to an alternative embodiment, in the step A) as shown in FIG. 1, the aqueous dispersion is provided by a commercial vendor.

As used herein, the term “acrylic” in the present invention includes (meth)acrylic acid, alkyl (meth)acrylate, (meth)acrylamide, (meth)acrylnitrile and their modified forms such as hydroxyalkyl (meth)acrylate. For example, (meth)acrylic acid refers to both methacrylic acid and acrylic acid, and methyl (meth)acrylate refers to both methyl methacrylate and methyl acrylate. According to an embodiment of the present application, the acrylic monomer for preparing the acrylic or styrene-acrylic particles (a) can be linear or branched (C₁-C₂₂)alkyl (meth)acrylate, (C₃-C₂₂)cycloalkyl (meth)acrylate or (C₆-C₂₂)aryl (meth)acrylate, and exemplary acrylic monomer can be selected from the group consisting of acrylic acid, methacrylic acid, hydroxyethyl methacrylate, methyl acrylate, methyl methacrylate, ethyl acrylate, ethyl methacrylate, propyl acrylate, propyl methacrylate, butyl acrylate, butyl methacrylate, 2-ethylhexyl acrylate, 3-butanediol dimethacrylate, acrylonitrile, iso-butyl (meth)acrylate, hexyl (meth)acrylate, lauryl (meth)acrylate, stearyl (meth)acrylate, cyclohexyl (meth)acrylate, benzyl(meth)acrylate, oleyl(meth)acrylate, palmityl (meth)acrylate, nonyl(meth)acrylate, decyl (meth)acrylate, dodecyl (meth)acrylate, pentadecyl (meth)acrylate, hexadecyl (meth)acrylate, octadecyl (meth)acrylate, hydroxyethyl (meth)acrylate, hydroxypropyl (meth)acrylate, acrylamide, methacrylamide, allyl (meth)acrylate, 2-methylallyl (meth)acrylate, allyl (meth)acrylamide, 2-methylallyl (meth)acrylamide, allyl oxyethyl (meth)acrylate, 2-methylallyl oxyethyl (meth)acrylate, crotyl (meth)acrylate, dicyclopentenyl (meth)acrylate and dicyclopentenyl ethyl (meth)acrylate, diallyl maleate, and any combinations thereof. According to an embodiment, the acrylic polymer comprises from 59 to 100 wt % of the above said acrylic monomer, based on the total weight of the acrylic polymer; such as from 65 to 95 wt %, or from 70 to 90 wt %, or from 75 to 85 wt %, or from 78 to 85 wt %, or within a numerical range obtained by combining any two of the above said end points.

According to another embodiment, the styrene monomer for the acrylic-styrene polymer can be styrene or a substituted styrene comprising one, two, three four or five substituents selected from the group consisting of a hydroxyl, a linear or branched C₁-C₁₂ alkyl, a linear or branched C₁-C₁₂ alkoxy, a C₃-C₁₂ cycloalkyl, a halogen, and a nitrile group. The styrene-acrylic polymer may comprise from 0.1 to 90 wt %, or from 10 to 80 wt %, or from 20 to 70 wt %, or from 30 to 60 wt %, or from 40 to 50 wt % of the above said styrene monomer, and from 10 to 90 wt %, or from 20 to 80 wt %, or from 30 to 70 wt %, or from 40 to 60 wt %, or from 45 to 55 wt % of the above said acrylic monomer, based on the total weight of the styrene-acrylic polymer.

According to another embodiment, the monomer raw materials for preparing the acrylic polymer or the acrylic-styrene polymer may further comprise one or more additional olefinically unsaturated monomers whose content can be from 0.1 to 20 wt %, or from 1 to 15 wt %, or from 5 to 10 wt %, based on the total weight of the polymer. The olefinically unsaturated monomer can be selected from the group consisting of itaconic acid, fumaric acid, maleic acid, maleic anhydride, itaconic anhydride, N-vinylformamide, N-vinylpyrrolidone, N-methyl-2-methyleneoxazolidine, 2-methylene-1, 3-thiolene, ethylene, propylene, isobutylene, butadiene, isoprene, vinyl methyl ether, vinyl isobutyl ether, vinylpyridine, β-aminoethyl vinyl ether, aminopentyl vinyl ether, vinyl acetate, sodium vinyl sulfonate, and any combinations thereof.

According to some embodiments, the aqueous dispersion of polymeric particles (a) comprising the acrylic polymer or the styrene-acrylic polymer can be prepared by any suitable method, such as by radical polymerization (e.g., emulsion polymerization) in which the above said acrylic monomer(s), styrene monomer(s) and optionally, the additional olefinically unsaturated monomer(s) react to produce a dispersion of acrylic or styrene-acrylic polymer particles dispersed in the aqueous medium. The radical polymerization can be conducted under ambient temperature or elevated temperature of e.g. from 30° C. to 150° C., or from 50° C. to 130° C., or from 60° C. to 100° C., or from 70° C. to 90° C.

Ordinary additives, such as catalyst, cocatalyst, chain transferring agent, initiator, surfactant, etc., can be properly introduced during the polymerization.

According to some embodiments, examples of surfactants include, but are not limited to, cationic surfactants, anionic surfactants, zwitterionic surfactants, non-ionic surfactants, and combinations thereof. Examples of anionic surfactants include, but are not limited to, alkylphenol ether sulfates, carboxylates, and phosphates, sodium dodecylbenzene sulfonate, alkyl alkoxylate sulfate/carboxylate or phosphate in which the alkyl group has from 8 to 20 carbon atoms. Examples of non-ionic surfactants include, but are not limited to, linear or branched aliphatic alcohols ethoxylate or alkoxylate, fatty methyl ethoxylate ester, sorbitan derivative.

According to some embodiments, the initiator can be either a thermal initiator or a redox initiator. Exemplary thermal initiator includes, but are not limited to, sodium persulfate and ammonium persulfate, and examples of the redox initiator consists of at least one reducing agent such as an ascorbic acid, a sulfoxylate, or an erythorbic acid, and at least one oxidant such as a peroxide or a persulfate.

According to some embodiments, a chain transfer agent may optionally be used in the polymerization. Exemplary chain transfer agent includes long chain alkyl mercaptans such as t-dodecyl mercaptans, methyl 3-mercaptopropionate, alcohols such as isopropanol, isobutanol, lauryl alcohol or t-octyl alcohol, carbon tetrachloride, tetrachloroethylene and trichloro-bromoethane.

According to some embodiments, at least one additive can be optionally post-added into the polymer. Examples of the at least one additive includes, but are not limited to, a thickener, a defoamer, a wetting agent, a mechanical stabilizer, a pigment, a filler, a freeze-thaw agent, a neutralizing agent, a plasticizer, a tackifier, an adhesion promoter, and any combinations thereof.

According to another embodiment, the aqueous dispersion comprising the polymeric particles (a) can be commercially available.

According to some embodiments, the aqueous dispersion comprising the polymeric particles (a), either prepared via polymerization or purchased from vendors, has a first free formaldehyde concentration as indicated above which needs to be further decreased, so as to meet the environmental regulations of a specific country/region or further enhance the product competitiveness.

According to some embodiments, the dispersion provided in Step B) has a pH value between 2.0 and 10.0, such as from 3.0 to 9.0, or from 4.0 to 7.5, or from 5.0 to 6.6.

In Step C) as shown in FIG. 1, the complex solution prepared in Step A) is added into the aqueous dispersion provided in Step B) and react with the free formaldehyde contained therein, thus reducing the free formaldehyde concentration to a second free formaldehyde concentration, wherein the second free formaldehyde concentration is less than 90% of the first free formaldehyde concentration, such as less than 70%, or less than 50%, or less than 30%, or less than 25%, or less than 20%, or less than 15%, or less than 10%, or less than 5%, or less than 1%, of the first free formaldehyde concentration. According to some embodiments, the second free formaldehyde concentration is less than 100 ppm, based on the weight of the resultant product, such as from 0.1 ppm to 50 ppm, or from 0.5 ppm to 20 ppm, or from 0.8 ppm to 10 ppm, or from 1 ppm to 5 ppm, or less than 2 ppm, based on the weight of the resultant product. The aqueous solution of said compound (b) and compound (c) can be directly added into the aqueous dispersion comprising particles (a) and the blend is thoroughly mixed by stirring to promote the formaldehyde-scavenging reaction. According to one embodiment, the formaldehyde-scavenging reaction can be conducted under ambient temperature or elevated temperature, such as from 15° C. to 100° C., or from 20° C. to 80° C., or from 25° C. to 60° C., or from 30° C. to 50° C.

According to some embodiments, the cyclic multi-carbonyl compound has a structure represented by any of Formulae I to XVI,

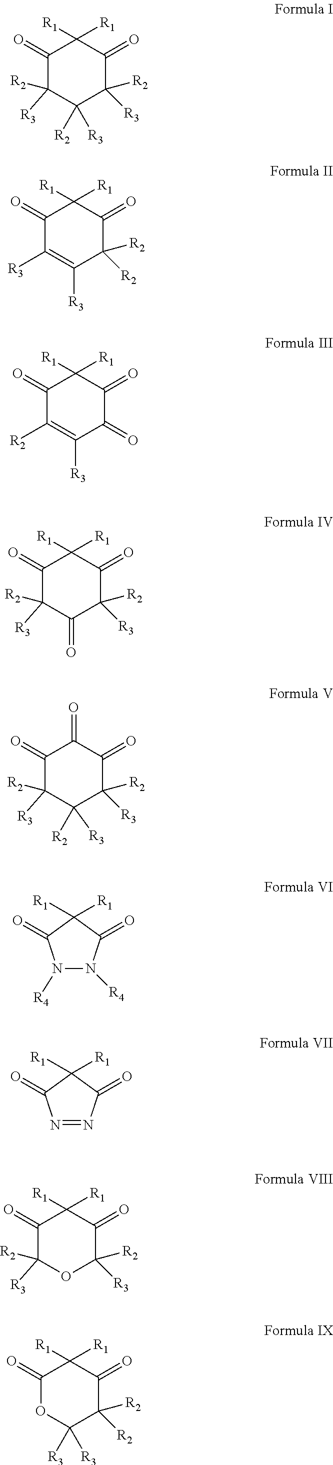

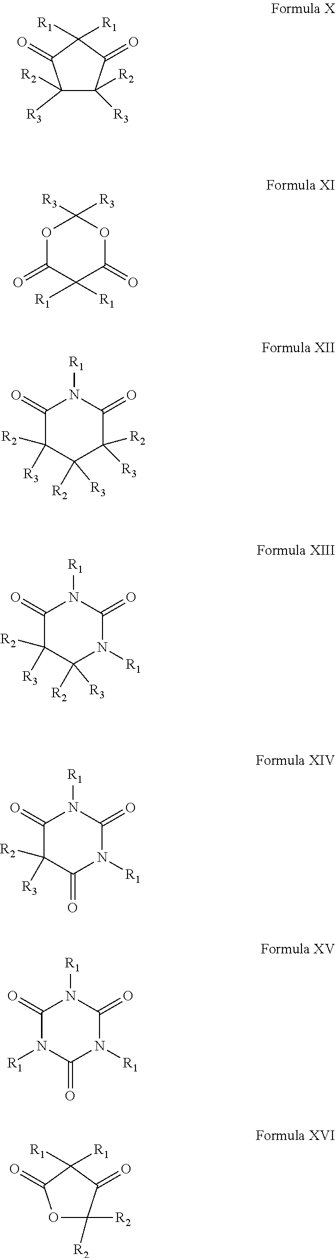

wherein each of R₁, R₂, R₃ and R₄ is independently selected from the group consisting of hydrogen, a linear or branched C₁-C₁₂ alkyl, a linear or branched C₁-C₁₂ alkoxy, a C₃-C₁₂ cycloalkyl, a C₆-C₁₂ aryl, a halogen, and a nitrile group. According to a particular embodiment, each of R₁, R₂, R₃ and R₄ is independently selected from the group consisting of hydrogen, a linear or branched C₁-C₆ alkyl, a linear or branched C₁-C₆ alkoxy, a C₃-C₆ cycloalkyl, and a C₆-C₉ aryl.

According to some embodiments, the cyclic multi-carbonyl compound is selected from the group consisting of cyclohexane-1,3-dione, 5,5-dimethylcyclohexane-1,3-dione, 5,5-diethylcyclohexane-1,3-dione, 6-methylcyclohexane-1,3-dione, 6-ethylcyclohexane-1,3-dione, cyclohexane-1,3,5-trione, pyrazolidine-3,5-dione, 1,2-dimethylpyrazolidine-3,5-dione, 1,2-diethylpyrazolidine-3,5-dione, 1-methylpyrazolidine-3,5-dione, 1-ethylpyrazolidine-3,5-dione, pyran-3,5-dione, 2-methyl-pyran-3,5-dione, pyran-2,4-dione, 6-methyl-pyran-2,4-dione, 6-ethyl-pyran-2,4-dione, 6-isopropyl-pyran-2,4-dione, 6-(n)-butyl-pyran-2,4-dione, 6-isobutyl-pyran-2,4-dione, 6-pentyl-pyran-2,4-dione, 6-isopentyl-pyran-2,4-dione, [1,3]-dioxan-4,6-dione, 2,2-dimethyl-[1,3]-dioxan-4,6-dione, 2,2-diethyl-[1,3]-dioxan-4,6-dione, 2,2-dipropyl-[1,3]-dioxan-4,6-dione, 2-phenyl-[1,3]-dioxan-4,6-dione, 2,4,6-trioxo-hexahydro-pyrimidine, 1-methyl-2,4,6-trioxo-hexahydro-pyrimidine, 1,3-dimethyl-2,4,6-trioxo-hexahydro-pyrimidine, 1,3-diethyl-2,4,6-trioxo-hexahydro-pyrimidine, 1-phenyl-2,4,6-trioxo-hexahydro-pyrimidine, furan-2,4(3H,5H)-dione, 3-methyl-furan-2,4(3H,5H)-dione, 3,3-dimethyl-furan-2,4(3H,5H)-dione, 3-ethyl-furan-2,4(3H,5H)-dione, 3,3-diethyl-furan-2,4(3H,5H)-dione, and any combinations thereof. For example, the cyclic multi-carbonyl compound can be cyclohexane-1,3-dione or 5,5-dimethylcyclohexane-1,3-dione.

According to some embodiments, the hydroxyl group-functionalized amine compound has a structure represented by Formula A:

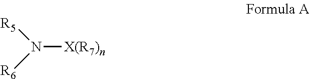

wherein X is a direct bond, a methylene group, a methylidyne group or a quaternary carbon group, n is an integer of 1, 2 or 3, and each of R₅, R₆ and R₇ is independently selected from the group consisting of hydrogen, a hydroxyl, a linear or branched C₁-C₁₂ alkyl, a C₆-C₁₂ aryl, a linear or branched C₁-C₁₂ hydroxyalkyl, a C₆-C₁₂ hydroxyaryl, —NR₈R₉, C₁-C₁₂ alkylene-NR₈R₉, C₁-C₁₂ hydroxyalkylene-NR₈R₉, a C₆-C₁₂ arylene-NR₈R₉, and a C₆-C₁₂ hydroxylarylene-NR₈R₉, wherein each of R₈ and R₉ is independently selected from the group consisting of hydrogen, a linear or branched C₁-C₁₂ alkyl, a C₆-C₁₂ aryl, a linear or branched C₁-C₁₂ hydroxyalkyl, and a C₆-C₁₂ hydroxyaryl; with the proviso that at least one of R₅, R₆ and R₇ comprise one or more hydroxyl group. According to a particular embodiment, each of R₅, R₆ and R₇ is independently selected from the group consisting of hydrogen, a hydroxyl, a linear or branched C₁-C₆ alkyl, a C₆-C₉ aryl, a linear or branched C₁-C₆ hydroxyalkyl, a C₆-C₉ hydroxyaryl, —NR₈R₉, C₁-C₆ alkylene-NR₈R₉, C₁-C₆ hydroxyalkylene-NR₈R₉, a C₆-C₉ arylene-NR₈R₉, and a C₆-C₉ hydroxylarylene-NR₈R₉, wherein each of R₈ and R₉ is independently selected from the group consisting of hydrogen, a linear or branched C₁-C₆ alkyl, a C₆-C₉ aryl, a linear or branched C₁-C₆ hydroxyalkyl, and a C₆-C₉ hydroxyaryl; with the proviso that at least one of R₅, R₆ and R₇ comprise one or more hydroxyl group.

According to some particular embodiments, the hydroxyl group-functionalized amine compound has a structure represented by Formula AI, Formula AII, Formula AIII or Formula AIV when X is a direct bond, a methylene group, a methylidyne group or a quaternary carbon group, respectively,

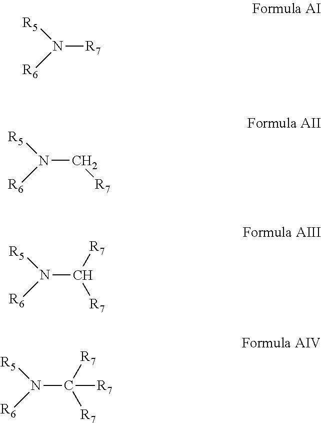

wherein R₅, R₆ and R₇ are as indicated above.

According to some particular embodiments, the hydroxyl group-functionalized amine compound has a hydroxyl functionality of 2 to 4, e.g., has a hydroxyl functionality of 3.

According to some particular embodiments, the hydroxyl group-functionalized amine 5 compound is selected from the group consisting of ethanolamine, diethanolamine, 1,1,1-tris (hydroxymethyl) methylamine, 1,1-di(hydroxymethyl)-1-(hydroxyethyl) methylamine, 1-di(hydroxyethyl)-1,1-(hydroxyethyl) methylamine, 1,1,1-tris (hydroxyethyl) methylamine, 2-amino-1-butanol, 2-amino-2-ethyl-1,3-propanediol, 2-amino-2-methyl-1-propanol, 2-amino-1-methyl-1,3-propanediol, N-methylethanolamine, N-butylethanolamine, monoisopropanolamine, 2-amino-2(hydroxymethyl)propane-1,3-diol, diisopropanolamine, mono-sec-butanolamine, di-sec-butanolamine, N-isopropylhydroxylamine, N-ethylhydroxylamine, N-methylhydroxylamine, N-butylhydroxylamine, N-(sec-butyl)hydroxylamine, the salts thereof, and any combinations thereof. For example, the hydroxyl group-functionalized amine compound can be 1,1,1-tris (hydroxymethyl) methylamine.

According to some particular embodiments, the combined concentration of the cyclic multi-carbonyl compound and the hydroxyl group-functionalized amine compound is from 20 to 1,000 ppm, based on the total weight of the aqueous dispersion, such as from 50 to 800 ppm, or from 100 to 700 ppm, or from 200 to 600 ppm, or from 250 to 500 ppm, or from 300 to 500 ppm, or within any numerical range obtained by combining any two of the above stated end points. According to an alternative embodiment, higher amount of the cyclic multi-carbonyl compound and the hydroxyl group-functionalized amine compound can be used when it is estimated that the aqueous dispersion comprising particles (a) further comprises some potential formaldehyde generating substance which may further emit free formaldehyde during the long-term storage and use. For example, the combined molar content of the cyclic multi-carbonyl compound and the hydroxyl group-functionalized amine compound can be more than one time, such as from 1 to 50 times of the total formaldehyde (i.e. the sum of free formaldehyde and potential formaldehyde-generating substance) contained in the aqueous dispersion comprising particles (a), such as from 1 to 30 times, or from 1 to 25 times or from 1 to 10 times of the total formaldehyde contained in the aqueous dispersion comprising particles (a). According to some embodiments, the molar ratio between the cyclic multi-carbonyl compound and the hydroxyl group-functionalized amine compound is from 1:1 to 1:10, such as from 1:1 to 1:5, or from 1:1 to 1:2.5, or from 1:1.25 to 1:2.5, or from 1:2 to 1:2.5, or within a scope obtained by combining any two of the above ratios.

According to some embodiments, after the treatment in Step C), there is no substantial change in the pH of the aqueous dispersion after the incorporation of the complex solution. For example, it may have a pH value between 2.0 and 10.0, such as from 3.0 to 9.0, or from 4.0 to 7.5, or from 5.0 to 6.6.

One or more additional steps, which are not shown in FIG. 1, can be optionally conducted before or after each of Step A) to C) according to the actual requirements, and examples of said additional steps include concentration, dilution, filtration, pH adjustment, or the incorporation of any additives as stated above.

The aqueous dispersion produced after the above said Step C) can be used as a product including an adhesive, a coating material, a paint, a primer, a sealing agent, etc., which may be used in various applications such as construction part, automotive part, furniture, interior decoration, container, package material, household appliance, manufacture apparatus, analysis device, etc.

On the basis of the particularly designed composition and methods, the following benefits have been successfully achieved:
a) Effective free formaldehyde removal in the acrylic or styrene-acrylic based aqueous dispersion;
b) Long-term inhibition of formaldehyde omission;
c) Superior discoloring resistance and viscosity stability;
d) Applicability at weak acidic, neutral and weak basic pH value; and
e) Excellent cost-effectiveness.

### EXAMPLES

Some embodiments of the invention will now be described in the following Examples, wherein all parts and percentages are by weight unless otherwise specified. However, the scope of the present disclosure is not, of course, limited to the formulations set forth in these examples. Rather, the Examples are merely inventive of the disclosure.

All the raw materials are commercial products and are used as is, the water used in the examples is deionized water, and the information of the main raw materials are listed in the following table 1:

TABLE 1
Raw materials used in the examples

| Grade name | Description | Vendor |
|---|---|---|
| Dimedone | Cyclic multi-carbonyl compound: | Sigma Aldrich |
| | 5,5-dimethyl-1,3-cyclohexanedione | |
| Tris-A | hydroxyl group-functionalized amine compound: | Sigma Aldrich |
| | 1,1,1-tris (hydroxymethyl) methylamine | |
| HPA-X | Comparative FA-removal agent: | The Dow Chemical Company |
| | Mixture of linear, branched, and cyclic ethyleneamines | |
| DETA | Comparative FA-removal agent: Diethylenetriamine; | The Dow Chemical Company |
| TETA | Comparative FA-removal agent: Triethylenetetramine | The Dow Chemical Company |
| PEI | Comparative FA-removal agent: | BASF |
| | Polyethylenimine having an average Molecular weight of | |
| | 800 Da | |

### Characterization Technologies:

### 1. Characterization of Free Formaldehyde Concentration.

In the following examples, the concentrations of free formaldehyde in any samples were characterized by HPLC, in accordance with GB/T 30982-2014 “LIMIT OF HAZARDOUS SUBSTANCES IN CONSTRUCTION ADHESIVE”, and particularly, according to the following procedures: about 0.1 g of DNPH was dissolved with 10 ml of phosphate acid by vortex for more than 2 min, and the resultant solution was labelled as “DNPH solution”. A stock standard purchased from J&K Chemical with a concentration of 1000 mg/L was diluted with ACN to produce standard series. 0.5 ml of the standard solution and 0.5 ml acetonitrile was transferred with a pipette into a 20-ml glass vial, and then derived with 0.05 ml “DNPH solution” for 24 hours. A blank sample was also prepared and characterized for the calculation curve.

The sample to be measured was dissolved in acetonitrile with a dilution factor of 8, then 0.5 ml of the resultant sample solution and 0.5 ml acetonitrile were transferred with a pipette into a 20-ml glass vial, and derived with 0.05 ml “DNPH solution” for 24 hours. A blank sample was also prepared and characterized for the calculation curve. The sample was tested by with HPLC coupled with UV detector having a peak wavelength at 360 nm. The instrument information and process conditions for the HPLC analysis are summarized in the following Table 2:

TABLE 2
Instrument information and process
conditions for the HPLC analysis

| Instrument: | Agilent HPLC 1200 | |
|---|---|---|
| Column: | Zorbax XDB-C18, 250 mm*4.6 mm, 5 μm | |
| Flow rate: | 1 ml/min | |
| Mobile Phase: | A: 0.1% H₃PO₄ in water | |
| | B: 0.1% H₃PO₄ in ACN | |
| | Time (min) | B % |
| Gradient: | 0 | 55 |
| | 20 | 55 |
| | 21 | 100 |
| | 26 | 100 |
| | 27 | 55 |
| | 32 | 55 |

| | |
|---|---|
| Temperature: | 25° C. |
| Detection: | wavelength at 360 nm |
| Injection volume: | 10 μL |

### 2. Color Test

About 23 g of liquid latex samples prepared in each of the following examples were separately poured into a plastic pan and were heated overnight in an oven at 70° C. to form a film. The L/A/B/ΔE value of the film was measured on a DATACOLOR Spectro 1000 spectrophotometer to evaluate the color change in the film.

### 3. pH Value

The pH value of each liquid sample was measured with the pH meter.

### 4. Viscosity

The viscosity of each liquid sample was measured by using a Brookfield LV #2 viscometer.

### 5. Accelerated Thermal Aging of Samples

The liquid latex samples prepared in each of the following examples were heated in an oven at 54° C. for one to six weeks, the samples were taken out after predetermined durations and subject to color test and free formaldehyde concentration test as stated above.

### Inventive Example 1

In this Example, a stock latex was prepared via the free radical polymerization of an aqueous emulsion of styrene and MMA. The stock latex is an aqueous dispersion of styrene-acrylic polymer particles having a solid content of 47.0 wt %, a pH of 6.6 and a viscosity of less than 75 cps. Although the raw materials have been carefully elected to minimize the introduction of any aldehyde-generation ingredients in the reaction system, detectable amount of formaldehyde was still contained in this stock latex.

A solution was prepared by dissolving 30.00 g Tris-A and 17.00 g Dimedone in 188.00 g DI water. 200.00 g of the stock latex was weighed and transferred into a kettle equipped with a stirring pad, and then 0.501 g of the solution was weighed and slowly added dropwise by using an eyedropper into the kettle under mild stirring. After the addition of the solution, the mixture within the kettle was further stirred for about 10 minutes to for a homogeneous aqueous dispersion.

The sample prepared in this example was subject to color test, free formaldehyde concentration test and accelerated thermal aging test as stated above, and the characterization results were summarized in Table 3.

### Comparative Examples 1 to 5

The Comparative Examples 1 to 5 were conducted by repeating the above said procedures and parameters of Inventive Example 1, except that the solution of Tris-A and Dimedone was omitted in the Comparative Example 1, and it was replaced with a solution of HPA-X, DETA, TETA and PEI in DI water at the same concentration for Comparative Examples 2, 3, 4 and 5, respectively.

The samples prepared in these comparative examples were similarly subject to color test, free formaldehyde concentration test and accelerated thermal aging test as stated above, and the characterization results were summarized in Table 3.

TABLE 3
The characterization results of Inventive Example (Ex.) 1 and Comparative Examples (Co. Ex.) 1-5

| Results | Description | | Ex. 1 | Co. Ex. 1 | Co. Ex. 2 | Co. Ex. 3 | Co. Ex. 4 | Co. Ex. 5 |
|---|---|---|---|---|---|---|---|---|
| FA removal | — | | Tris-A and | none | HPA-X | DETA | TETA | PEI |
| agent | | | Dimedone | | | | | |
| pH | — | | 6.82 | 6.65 | 6.87 | 6.72 | 6.69 | 6.69 |
| Viscosity | — | | 24 | 26 | 26 | 24 | 28 | 28 |
| Whiteness (L*) | 1 | day | 83 | 83.35 | 84.04 | 81.32 | 81.6 | 83.07 |
| Initial FA content | 0 | day | 1.5 | 13.7 | 11.6 | 7.1 | 11.4 | 11.7 |
| Whiteness (L*) | 15 | days | 81.31 | 80.23 | 80.27 | 79.98 | 80.81 | 78.7 |
| Post-aging FA | 22 | days | 3.3 | 14.9 | 13.5 | 9.0 | 10.4 | 11.3 |

content

As can be seen from the experimental results summarized in Table 3, the sample of Inventive Example 1 exhibits superior free formaldehyde removal efficiency, long term formaldehyde generation inhibition, and good discoloring resistance. Besides, it can be seen that the sample of inventive example 1 is the only one which is well applicable to weak acidic pH value.

### Inventive Example 2

The Inventive Example 2 was conducted by repeating the above said procedures and parameters of Inventive Example 1, except that the addition amounts of Tris-A and Dimedone were adjusted while the total mass thereof were kept constant. In particular, a solution was prepared by dissolving 24.41 g Tris-A and 22.59 g Dimedone in 188.00 g DI water. 200.00 g of the stock latex was weighed and transferred into a kettle equipped with a stirring pad, and then 0.501 g of the solution was weighed and slowly added dropwise by using an eyedropper into the kettle under mild stirring. After the addition of the solution, the mixture within the kettle was further stirred for about 10 minutes to for a homogeneous aqueous dispersion.

The sample prepared in this example was subject to free formaldehyde concentration test as stated above, and the characterization results were listed in Table 4.

### Inventive Example 3

The Inventive Example 3 was conducted by repeating the above said procedures and parameters of Inventive Example 1, except that the addition amounts of Tris-A and Dimedone were adjusted while the total mass thereof were kept constant. In particular, a solution was prepared by dissolving 21.79 g Tris-A and 25.21 g Dimedone in 188.00 g DI water. 200.00 g of the stock latex was weighed and transferred into a kettle equipped with a stirring pad, and then 0.501 g of the solution was weighed and slowly added dropwise by using an eyedropper into the kettle under mild stirring. After the addition of the solution, the mixture within the kettle was further stirred for about 10 minutes to for a homogeneous aqueous dispersion.

The sample prepared in this example was subject to free formaldehyde concentration test as stated above, and the characterization results were listed in Table 4.

TABLE 4
Formulations and free formaldehyde removal
results of the Inventive Examples 1-3.

| | Ex. 1 | Ex. 2 | Ex. 3 |
|---|---|---|---|
| Stock latex, g | 200.00 | 200.00 | 200.00 |
| 20% FA Scavenger solution, g | 0.501 | 0.501 | 0.501 |
| Total weight, g | 200.501 | 200.501 | 200.501 |
| Dimendone/Tirs-A molar ratio | 0.49 | 0.8 | 1.0 |
| Free formaldehyde, ppm content | 1.5 | 2.0 | 1.9 |

The free formaldehyde removal results of all the inventive examples 1-3 were summarized in Table 4, from which it can be seen that the relative contents of Dimedone/Tris-A used in the Inventive Example 1 could achieve the highest formaldehyde-scavenging effect.

1. An aqueous polymeric composition, comprising
(a) an aqueous dispersion of polymeric particles comprising acrylic polymer, styrene-acrylic polymer or a combination thereof, wherein the aqueous dispersion comprises formaldehyde;
(b) at least one cyclic multi-carbonyl compound; and
(c) at least one hydroxyl group-functionalized amine compound,
wherein the at least one cyclic multi-carbonyl compound and the at least one hydroxyl group-functionalized amine compound are formaldehyde-scavenging.

2. The aqueous polymeric composition of claim 1, wherein the cyclic multi-carbonyl compound has a structure represented by any of Formulae I to XVI, 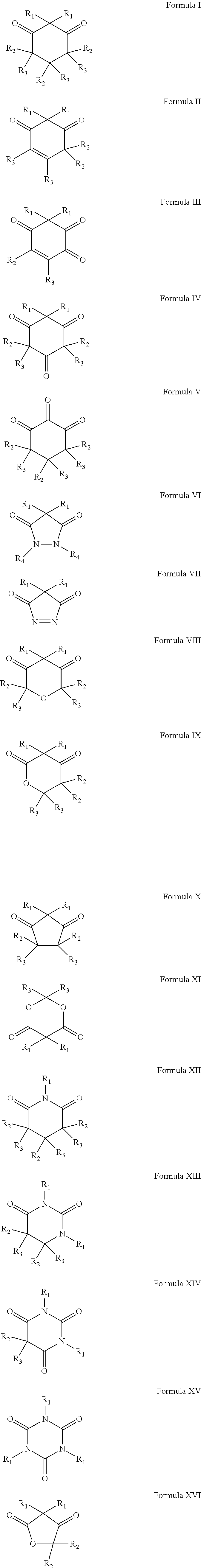
wherein each of R₁, R₂, R₃ and R₄ is independently selected from the group consisting of hydrogen, a linear or branched C₁-C₁₂ alkyl, a linear or branched C₁-C₁₂ alkoxy, a C₃-C₁₂ cycloalkyl, a C₆-C₁₂ aryl, a halogen, and a nitrile group.

3. The aqueous polymeric composition of claim 2, wherein the cyclic multi-carbonyl compound is selected from the group consisting of cyclohexane-1,3-dione, 5,5-dimethylcyclohexane-1,3-dione, 5,5-diethylcyclohexane-1,3-dione, 6-methylcyclohexane-1,3-dione, 6-ethylcyclohexane-1,3-dione, cyclohexane-1,3,5-trione, pyrazolidine-3,5-dione, 1,2-dimethylpyrazolidine-3,5-dione, 1,2-diethylpyrazolidine-3,5-dione, 1-methylpyrazolidine-3,5-dione, 1-ethylpyrazolidine-3,5-dione, pyran-3,5-dione, 2-methyl-pyran-3,5-dione, pyran-2,4-dione, 6-methyl-pyran-2,4-dione, 6-ethyl-pyran-2,4-dione, 6-isopropyl-pyran-2,4-dione, 6-(n)-butyl-pyran-2,4-dione, 6-isobutyl-pyran-2,4-dione, 6-pentyl-pyran-2,4-dione, 6-isopentyl-pyran-2,4-dione, [1,3]-dioxan-4,6-dione, 2,2-dimethyl-[1,3]-dioxan-4,6-dione, 2,2-diethyl-[1,3]-dioxan-4,6-dione, 2,2-dipropyl-[1,3]-dioxan-4,6-dione, 2-phenyl-[1,3]-dioxan-4,6-dione, 2,4,6-trioxo-hexahydro-pyrimidine, 1-methyl-2,4,6-trioxo-hexahydro-pyrimidine, 1,3-dimethyl-2,4,6-trioxo-hexahydro-pyrimidine, 1,3-diethyl-2,4,6-trioxo-hexahydro-pyrimidine, 1-phenyl-2,4,6-trioxo-hexahydro-pyrimidine, furan-2,4(3H,5H)-dione, 3-methyl-furan-2,4(3H,5H)-dione, 3,3-dimethyl-furan-2,4(3H,5H)-dione, 3-ethyl-furan-2,4(3H,5H)-dione, 3,3-diethyl-furan-2,4(3H,5H)-dione, and any combinations thereof.

4. The aqueous polymeric composition of claim 1, wherein the hydroxyl group-functionalized amine compound has a structure represented by Formula A: 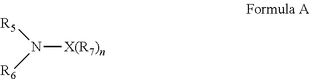
wherein X is a direct bond, a methylene group, a methylidyne group or a quaternary carbon group, n is an integer of 1, 2 or 3, and each of R₅, R₆ and R₇ is independently selected from the group consisting of hydrogen, a hydroxyl, a linear or branched C₁-C₁₂ alkyl, a C₆-C₁₂ aryl, a linear or branched C₁-C₁₂ hydroxyalkyl, a C₆-C₁₂ hydroxyaryl, —NR₈R₉, C₁-C₁₂ alkylene-NR₈R₉, C₁-C₁₂ hydroxyalkylene-NR₈R₉, a C₆-C₁₂ arylene-NR₈R₉, and a C₆-C₁₂ hydroxylarylene-NR₈R₉, wherein each of each of R₈ and R₉ is independently selected from the group consisting of hydrogen, a linear or branched C₁-C₁₂ alkyl, a C₆-C₁₂ aryl, a linear or branched C₁-C₁₂ hydroxyalkyl, and a C₆-C₁₂ hydroxyaryl; with the proviso that at least one of R₅, R₆ and R₇ comprise one or more hydroxyl group.

5. The aqueous polymeric composition of claim 4, wherein the hydroxyl group-functionalized amine compound is selected from the group consisting of ethanolamine, diethanolamine, 1,1,1-tris (hydroxymethyl) methylamine, 1,1-di(hydroxymethyl)-1-(hydroxyethyl) methylamine, 1-di(hydroxyethyl)-1,1-(hydroxyethyl) methylamine, 1,1,1-tris (hydroxyethyl) methylamine, 2-amino-1-butanol, 2-amino-2-ethyl-1,3-propanediol, 2-amino-2-methyl-1-propanol, 2-amino-1-methyl-1,3-propanediol, N-methylethanolamine, N-butylethanolamine, monoisopropanolamine, 2-amino-2(hydroxymethyl)propane-1,3-diol, diisopropanolamine, mono-sec-butanolamine, di-sec-butanolamine, N-isopropylhydroxylamine, N-ethylhydroxylamine, N-methylhydroxylamine, N-butylhydroxylamine, N-(sec-butyl)hydroxylamine, the salts thereof, and any combinations thereof.

6. The aqueous polymeric composition of claim 1, wherein the aqueous dispersion has a pH value between 2.0 and 10.0.

7. The aqueous polymeric composition of claim 1, wherein the combined concentration of the cyclic multi-carbonyl compound and the hydroxyl group-functionalized amine compound is from 20 to 1,000 ppm, based on the weight of the aqueous dispersion; and
the molar ratio between the cyclic multi-carbonyl compound and the hydroxyl group-functionalized amine compound is from 1:1 to 1:10.

8. A product obtained from the aqueous polymeric composition of claim 1, wherein the aqueous product is an adhesive, a coating material, a paint, a primer or a sealing agent, and
wherein the product has a free formaldehyde concentration of less than that in the aqueous dispersion.

9. A method for preparing a product with reduced formaldehyde by using the aqueous polymeric composition of claim 1, wherein the product is an adhesive, a coating material, a paint, a primer or a sealing agent, and the method comprising:
combining the aqueous dispersion comprising polymeric particles comprising acrylic polymer, styrene-acrylic polymer or a combination thereof, with the cyclic multi-carbonyl compound and the hydroxyl group-functionalized amine compound to reduce the formaldehyde content contained in the aqueous dispersion.

10. A method for reducing formaldehyde content in the product of claim 8, comprising:
providing an aqueous dispersion comprising polymeric particles comprising acrylic polymer, styrene-acrylic polymer or a combination thereof, wherein the aqueous dispersion has a first free formaldehyde concentration; and
adding the cyclic multi-carbonyl compound and the hydroxyl group-functionalized amine compound into the aqueous dispersion so as to reduce the formaldehyde to a second free formaldehyde concentration, wherein the second free formaldehyde concentration is less than 90% of the first free formaldehyde concentration.
